(19) United States
(12) Patent Application Publication
(10) Pub. No.: US 2014/0239609 A1
(43) Pub. Date: Aug. 28, 2014

(54) CARGO TRUCK MULTI-STAGE EXTENDABLE PERSONNEL PLATFORM

(71) Applicant: ROM Acquisition Corporation, Belton, MO (US)

(72) Inventor: Timothy D. Robertson, Easton, PA (US)

(73) Assignee: ROM Acquisition Corporation, Belton, MO (US)

(21) Appl. No.: 14/179,979

(22) Filed: Feb. 13, 2014

Related U.S. Application Data
(60) Provisional application No. 61/767,897, filed on Feb. 22, 2013.

(51) Int. Cl. B60R 3/02

(52) U.S. Cl. CPC B60R 3/02
USPC 280/166

(57) ABSTRACT

A personnel platform for installation on a cargo truck comprises a mounting bracket securely fastened to a framing structure of the cargo truck beneath a personnel door, a platform deck mounted to a sliding mechanism securely fastened to the mounting bracket, wherein the platform deck is operable to be slidably configured in a stowed position beneath the cargo truck and a deployed position extending substantially horizontally beyond the cargo truck, and a latching mechanism operable to lock the platform deck in one of the stowed position and the deployed position.

### RELATED APPLICATION

This application claims the benefit of U.S. Provisional Patent Application Ser. No. 61/767,897, entitled “Cargo Truck Extendable Personnel Platform,” filed on Feb. 22, 2013.

### FIELD

The present disclosure primarily relates to an extendable personnel platform for a cargo truck and other vehicles.

### BACKGROUND

According to the United States Department of Transportation, over twelve thousand million tons of freight were transported by trucks in the United States in 2010. The trucking industry provides an essential service to the American economy by transporting large quantities of raw materials, works in process, and finished goods over land—typically from manufacturing plants to retail distribution centers. Some cargo trucks are equipped with a side personnel door for ease of access to the cargo compartment.

### DESCRIPTION OF THE DRAWINGS

The present disclosure describes various embodiments illustrated in the drawing figures in which like reference numerals refer to like parts throughout the various views unless otherwise specified.

FIGS. 1A-1C are perspective views of the deployment of a preferred embodiment of a multi-stage extendable personnel platform according to the teachings of the present disclosure;

FIG. 2 is another perspective view of a preferred embodiment of a multi-stage extendable personnel platform according to the teachings of the present disclosure;

FIG. 3 is a side view of a preferred embodiment of a multi-stage extendable personnel platform equipped with a two-step ladder accessory in the stowed position according to the teachings of the present disclosure;

FIG. 4 is a side view of a preferred embodiment of a multi-stage extendable personnel platform equipped with a three-step ladder accessory in the stowed position according to the teachings of the present disclosure;

FIG. 5 is a side view of a preferred embodiment of a multi-stage extendable personnel platform equipped with a two-step ladder accessory in the fully-deployed position according to the teachings of the present disclosure;

FIG. 6 is a side view of a preferred embodiment of a multi-stage extendable personnel platform equipped with a three-step ladder accessory in the fully-deployed position according to the teachings of the present disclosure;

FIGS. 7-10 are various views illustrating the stages of deployment of a preferred embodiment of a multi-stage extendable personnel platform according to the teachings of the present disclosure; and

FIG. 11 is a perspective view of a preferred embodiment of a multi-stage extendable personnel platform equipped with a three-step ladder and guard rail accessories according to the teachings of the present disclosure.

### DETAILED DESCRIPTION

The present disclosure is directed to a multi-stage extendable personnel platform for installation on a cargo truck to permit personnel to easily access compartments and cargo through the body side door and enable staging cargo for delivery. The mounting envelope of the platform is small enough to allow the unit to be mounted underneath the cargo body of straight trucks (body on frame construction) in addition to trailers. Since the unit is designed for under-body mounting it does not require extensive body structure or floor modifications and may be installed as an accessory item as well as being able to be offered as truck or trailer original equipment.

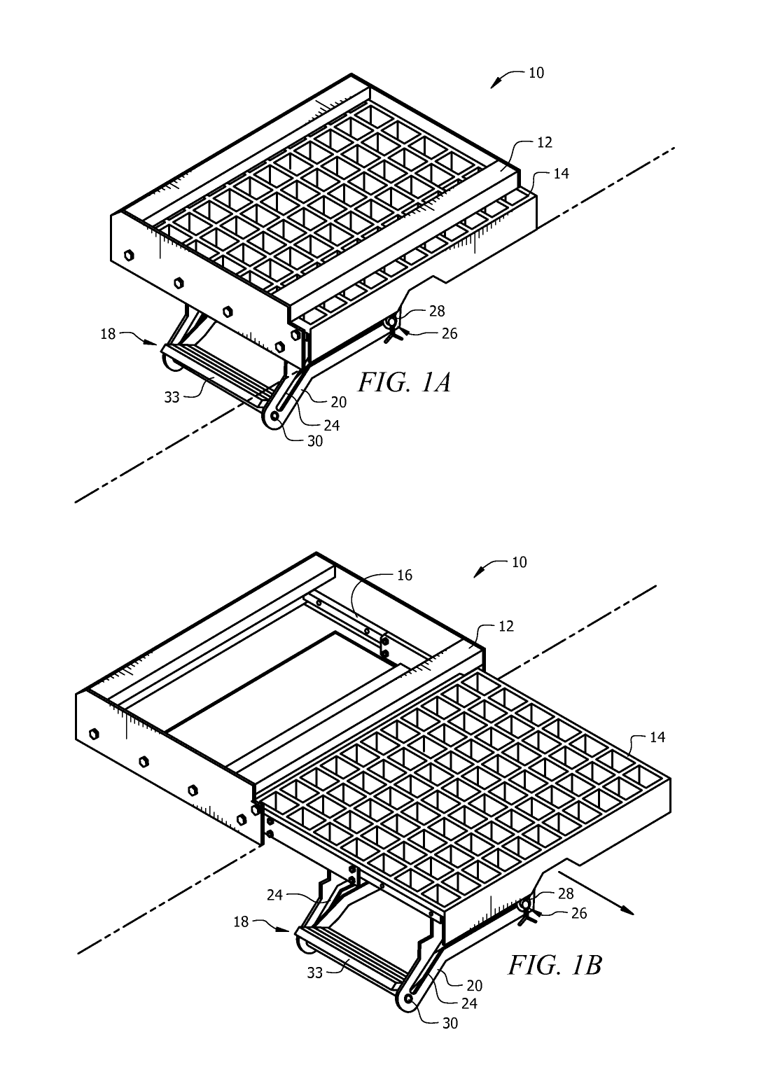

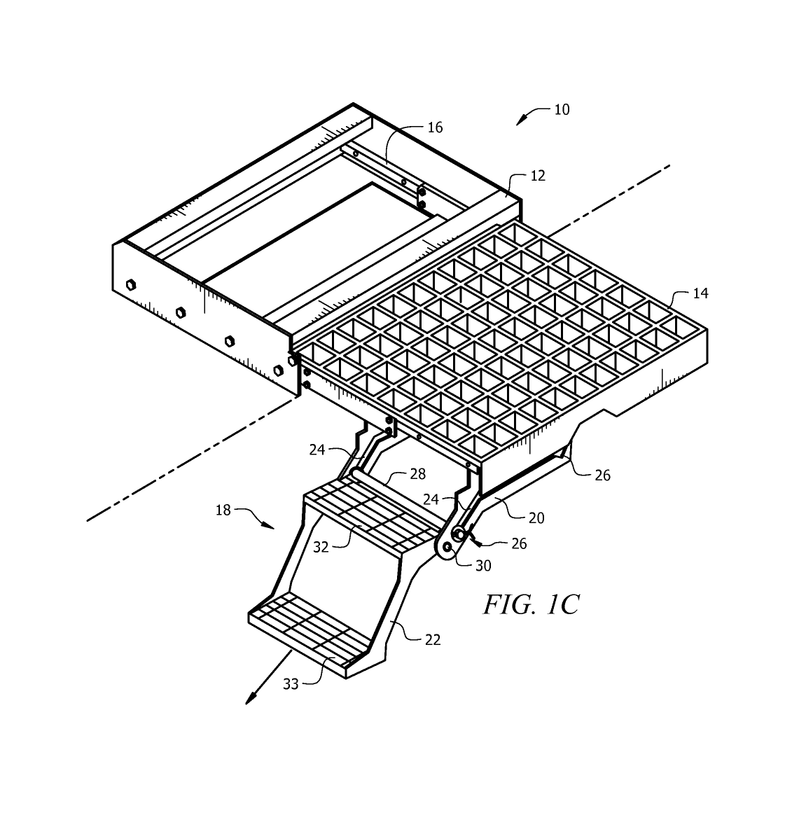

FIGS. 1A-1C are perspective views of the deployment of a preferred embodiment of a multi-stage extendable personnel platform 10 according to the teachings of the present disclosure. The multi-stage extendable personnel platform 10 includes a mounting bracket 12 that is mounted to a cargo truck. The mounting bracket 12 is adapted to be mounted to the frame or other rigid structures under the body of a cargo truck. The platform 10 is designed to be installed under a side door sill and truck body cross bar. The platform mounting envelope is sized to be easily accommodated within the existing framework of the truck body so that no substantial alteration to the trailer is needed. The mounting bracket 12 accommodates a deck 14 that is mounted to a sliding mechanism 16 of the mounting bracket 12. The sliding mechanism 16 enables the deck 14 to be within the mounting bracket 12 under the truck body in a stowed position, and slide out from the mounting bracket 12 in the fully-extended deployed position. Any suitable sliding mechanism using sturdy sliding rails, bearings, etc. may be used. The sliding mechanism 16 is mounted to the mounting bracket 12 that securely fastens the platform 10 to the truck body framing structure. A latching mechanism to be described in more detail below is used to engage and lock the platform deck 14 in either position.

The multi-stage extendable personnel platform 10 may be equipped with a ladder accessory 18. The ladder accessory 18 includes a mount 20 that may be securely bolted underneath the deck 14. A ladder is slidably engaged in the slots 24 defined in the side rails 22 to enable the ladder to be stowed under the deck 14 or be fully-extended and lowered for use. The slots 24 define a detent 26 into which a first crossbar 28 of the ladder rests while it is stowed. The first crossbar 28 is slidably engaged with the slots 24 to enable the ladder to be stowed or extended. The first crossbar 28 may be securely engaged in the slots 24 using cotter pins or other suitable means. A second crossbar 30 securely fastened across the lower end of the side rails 22 supports the ladder and prevents further rotation about the first crossbar 28 when the ladder is in the fully-extended position.

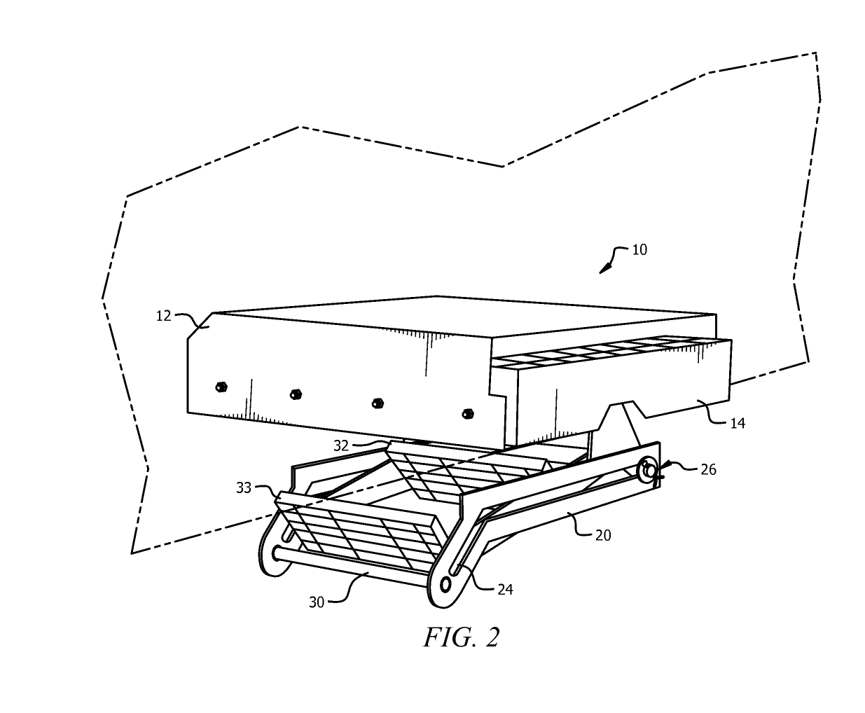

FIG. 1A shows the platform 10 in the fully-stowed position, FIG. 1B shows the deck 14 to be fully-deployed in the extended position, and FIG. 1C shows a two-step ladder accessory 18 mounted under the deck 14 in the fully-extended and lowered position. FIGS. 1A-1C shows a two-step ladder accessory with steps 32 and 33. FIG. 2 is another perspective view of a preferred embodiment of the multi-stage extendable personnel platform 10 with a two-step ladder accessory in the fully-stowed position. It may be seen in these figures that the deck and ladder steps are preferably constructed with a non-slippery configuration or material, such as aluminum, steel, and fiberglass. Alternatively, the deck and ladder steps may be surfaced with slippery resistant coatings to reduce or eliminate the risk of falls.

Although the ladder accessory is shown to extend and deploy along an axis perpendicular to the deployment axis of the personnel deck, other configurations are also contemplated. Such as configuring the ladder accessory extension to be along the same axis as the platform deck, or providing a mount for the ladder accessory that can be pivoted or rotated to different angles relative to the personnel platform for ease of use in tight or awkward spaces.

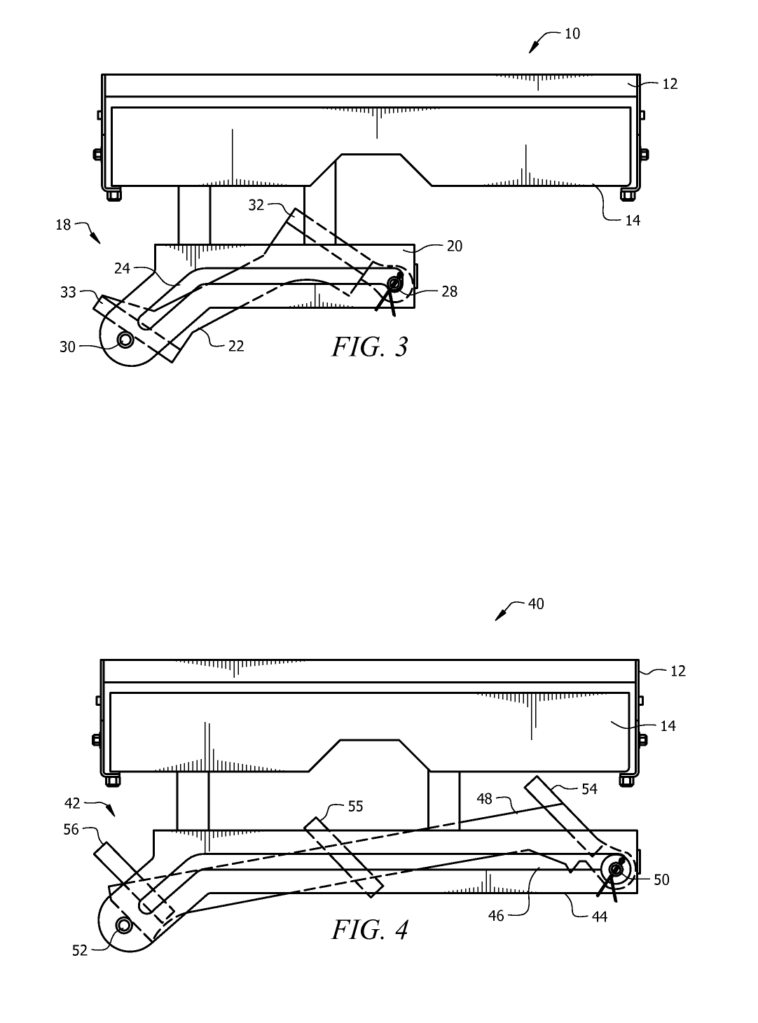

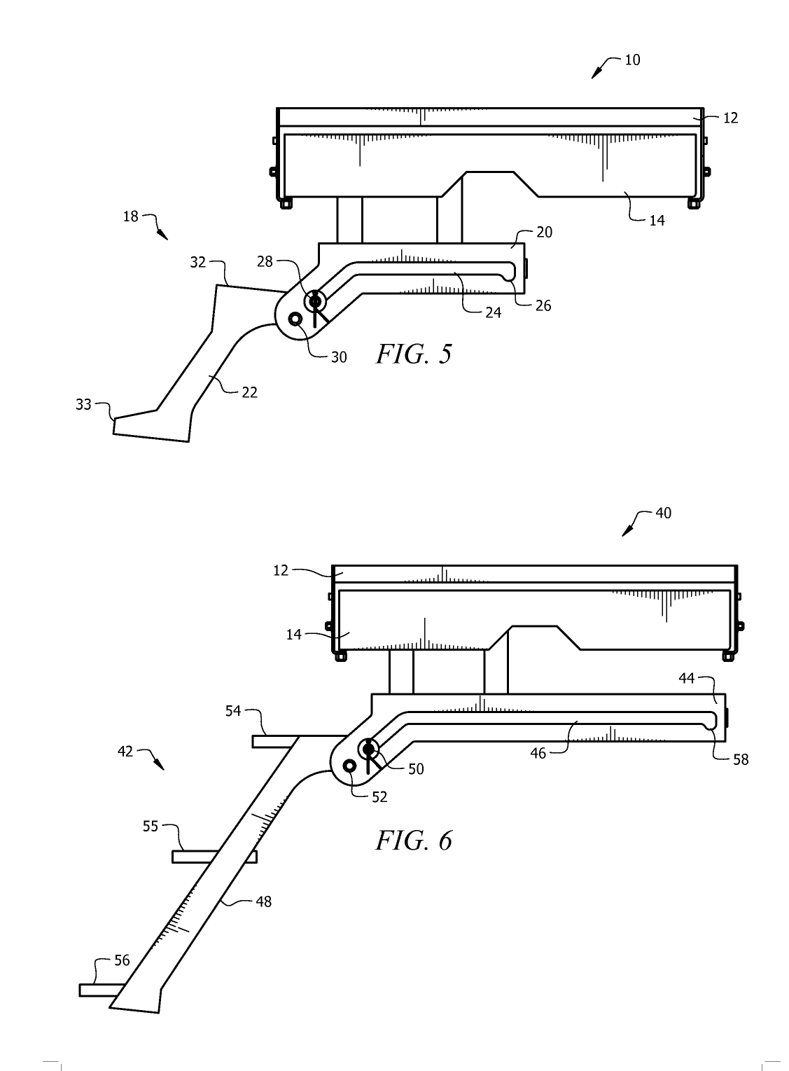

FIG. 3 is a side view of a preferred embodiment of the multi-stage extendable personnel platform 10 equipped with the two-step ladder accessory 18 in the stowed position according to the teachings of the present disclosure. The platform is preferably installed under the body of a cargo truck beneath a personnel side door. FIG. 5 shows the same two-step ladder accessory 18 in the fully extended position.

FIG. 4 is a side view of a preferred embodiment of a multi-stage extendable personnel platform 40 equipped with a three-step ladder accessory 42 in the stowed position according to the teachings of the present disclosure. The ladder accessory 42 includes a mount 44 that may be securely bolted underneath the deck 14. A ladder is slidably engaged in the slots 46 defined in the side rails 48 to enable the ladder to be stowed under the deck 14 or be fully-extended and lowered for use. The ladder includes a first crossbar 50 that is slidably engaged with the slots 46 to enable the ladder to be stowed or extended. A second crossbar 52 securely fastened to the side rails 48 supports the ladder and prevents further rotation about the first crossbar 50 in the fully-extended position. This ladder accessory 42 includes three steps 54-56. FIG. 6 shows the same three-step ladder accessory 42 in the fully extended position. In this view, the detent 58 defined in the slots 46 are clearly visible. The detent 58 serves to catch and retain the first crossbar 50 while the stowed position.

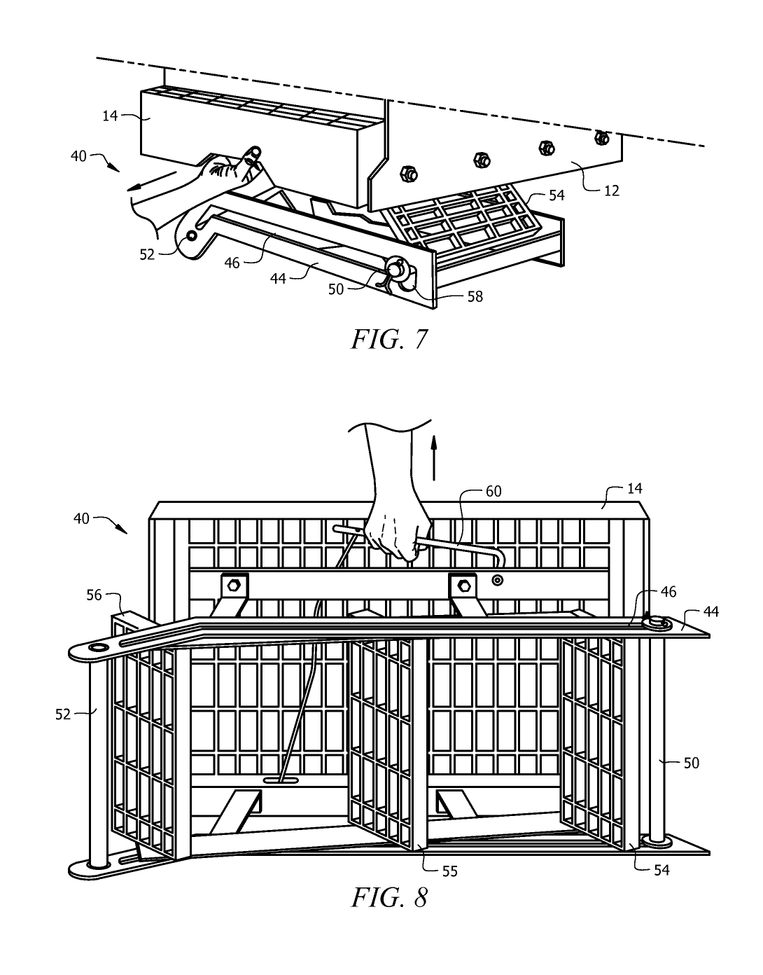

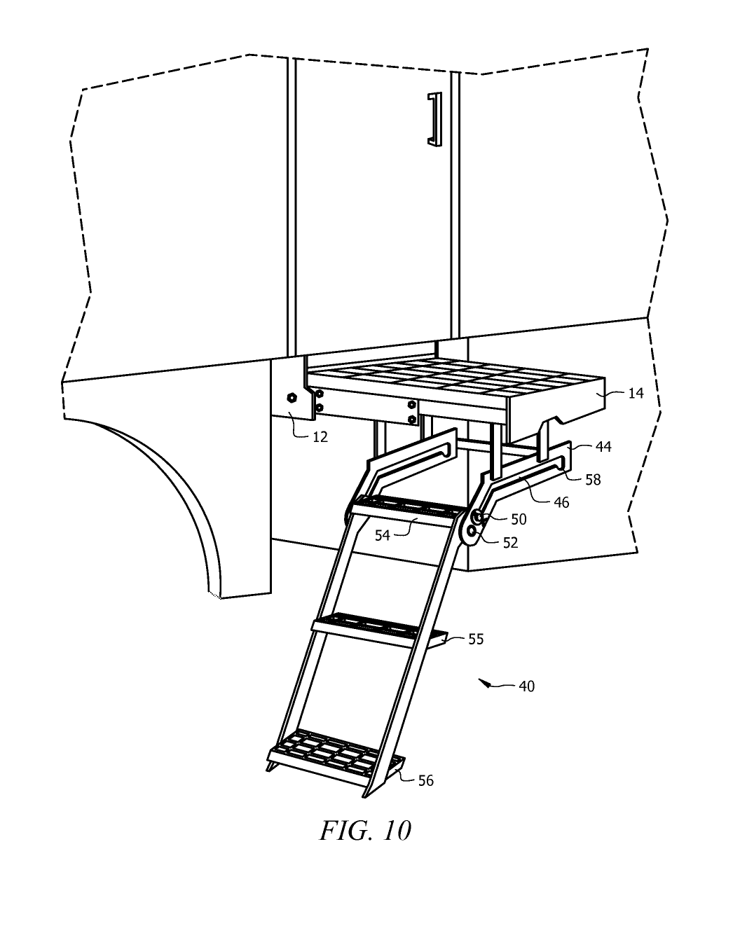

FIGS. 7-10 are various views illustrating the stages of deployment of a preferred embodiment of a multi-stage extendable personnel platform according to the teachings of the present disclosure. The deck 14 can be released and extended by pulling on a lever 60 located under the deck 14. The lever 60 releases a latching mechanism that securely locks the deck 14 in the stowed position while not in use. When the user activates the release lever 60, the deck 14 can be pulled out from the mounting bracket 12 and truck body, as shown in FIGS. 7 and 8. When the deck 14 reaches the fully-extended position, the latch mechanism again securely locks the deck 14 in the extended position, until the user activates the release lever 60 again to return it to the stowed position.

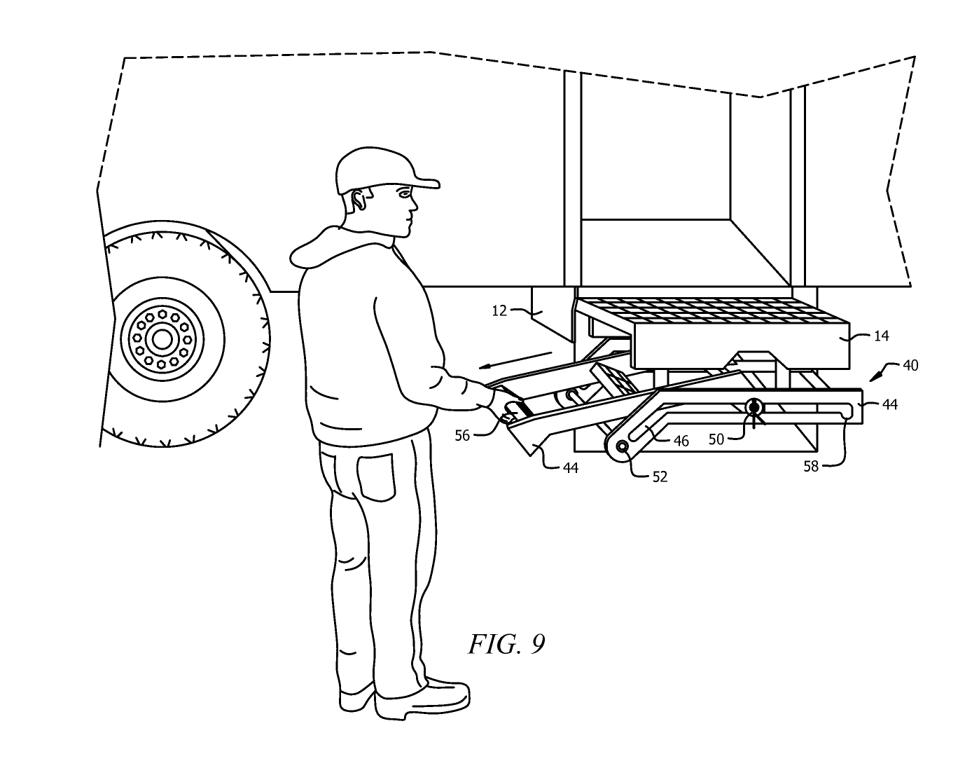

In FIG. 9, the user is shown partially deploying the ladder from under the deck 14 by pulling the ladder so that the first crossbar 50 disengages from the detent 58 and slides along the slots 46 defined in the side rails 44. The user may continue to pull the ladder out from under the deck 14 until the first crossbar 50 reaches the lower end of the slots 46. The user may then lower the ladder and allow it to rest upon the second crossbar 52 disposed across the lower end of the side rails 44. The second crossbar 52 supports the ladder and prevents further rotation about the first crossbar 50 when the ladder is in the fully-extended position.

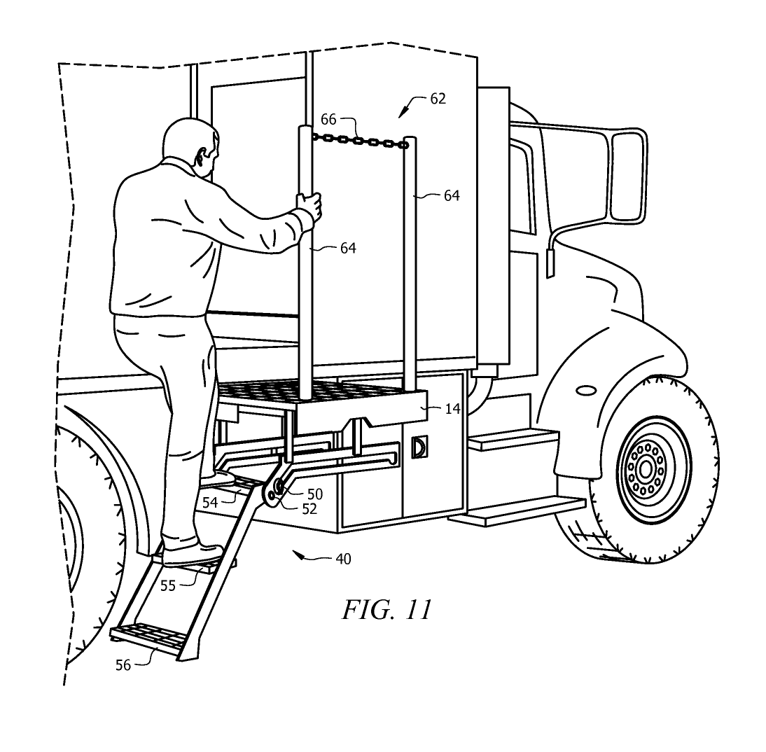

FIG. 11 is a perspective view of a preferred embodiment of a multi-stage extendable personnel platform 40 equipped with a three-step ladder and guard rail accessories according to the teachings of the present disclosure. In addition to the ladder accessory, the platform may be equipped with a rail accessory 62, one example of which is shown in FIG. 11. The rail accessory 62 may include one or more vertical posts 64 that can be inserted and securely seated in special openings in the deck 14 after the platform and ladder are fully deployed. Horizontal posts or other forms of support, such as a chain 66 as shown in FIG. 11, form a hand railing between the vertical posts 64. The rail accessory 62 is designed to be easily installed whenever needed, and is adapted to provide lateral support to the user for added safety when needed.

Constructed in the manner described herein, the platform and the ladder and railing accessories provide a sturdy access route to the cargo compartment that can be easily deployed. When not in use, the platform and accessories are stowed out of the way and out of sight within a small confined mounting envelope. The platform mounting envelope is sized to be easily accommodated within the existing framework of the truck body so that no substantial alteration to the trailer is needed. The platform is also sized, configured, and rated for staging cargo via the personnel side door. Typically the trailers are filled to the maximum with cargo, leaving very little space for workers to stage the cargo for unloading.

The personnel platform and accessories may be installed on a cargo truck, as described herein, and also finds application with other forms of vehicles such as recreational vehicles, fire trucks, emergency vehicles, etc. where easy-deployable access for personnel is needed. The personnel platform and accessories may even be used on stationary structures where needed.

The features of the present invention which are believed to be novel are set forth below with particularity in the appended claims. However, modifications, variations, and changes to the exemplary embodiments described above will be apparent to those skilled in the art, and the cargo truck multi-stage extendable personnel platform described herein thus encompasses such modifications, variations, and changes and are not limited to the specific embodiments described herein.

What is claimed is:

1. A personnel platform for installation on a cargo truck comprising:
a mounting bracket securely fastened to a framing structure of the cargo truck beneath a personnel door;
a platform deck mounted to a sliding mechanism securely fastened to the mounting bracket, wherein the platform deck is operable to be slidably configured in a stowed position beneath the cargo truck and a deployed position extending substantially horizontally beyond the cargo truck; and
a latching mechanism operable to lock the platform deck in one of the stowed position and the deployed position.

2. The personnel platform of claim 1, further comprising a ladder accessory having at least one step coupled to the platform deck.

3. The personnel platform of claim 1, further comprising a ladder accessory having at least one step coupled to the platform deck and operable to be slidably configured in a stowed position beneath the platform deck and a deployed position extending beyond the platform deck.

4. The personnel platform of claim 1, wherein the platform deck is slidably configured along a first axis, and the ladder accessory is slidably configures along a second axis perpendicular to the first axis.

5. The personnel platform of clam 1, further comprising a release handle operable to release and lock the latching mechanism.

6. The personnel platform of claim 1, wherein the mounting bracket comprises sliding rails slidably engaging the platform deck.

7. The personnel platform of claim 1, further comprising a ladder accessory including:
a ladder having a plurality of steps;
a pair of side rails coupled to the platform deck and defining a pair of elongated slots, the slots defining a detent at one end adapted to engage the ladder in a fully-stowed position, and a termination end adapted to engage the ladder in a fully-extended and lowered position.

8. The personnel platform of claim 1, further comprising a safety railing detachably mounted on the platform deck.

9. A personnel platform comprising:
a mounting bracket securely fastened to a framing structure beneath a personnel door;
a platform deck mounted to a sliding mechanism securely fastened to the mounting bracket, wherein the platform deck is operable to be slidably configured in a stowed position beneath the framing structure and a deployed position extending substantially horizontally beyond the personnel door;
a latching mechanism operable to lock the platform deck in one of the stowed position and the deployed position; and
a ladder accessory having at least one step coupled to the platform deck.

10. The personnel platform of claim 9, wherein the ladder accessory is operable to be slidably configured in a stowed position beneath the platform deck and a deployed position extending beyond the platform deck.

11. The personnel platform of claim 10, wherein the platform deck is slidably configured along a first axis, and the ladder accessory is slidably configures along a second axis perpendicular to the first axis.

12. The personnel platform of clam 9, further comprising a release handle operable to release and lock the latching mechanism.

13. The personnel platform of claim 9, wherein the mounting bracket comprises sliding rails slidably engaging the platform deck.

14. The personnel platform of claim 9, wherein the ladder accessory comprises:
a ladder having a plurality of steps;
a pair of side rails coupled to the platform deck and defining a pair of elongated slots, the slots defining a detent at one end adapted to engage the ladder in a fully-stowed position, and a termination end adapted to engage the ladder in a fully-extended and lowered position.

15. The personnel platform of claim 9, further comprising a safety railing detachably mounted on the platform deck.

16. A personnel platform comprising:
a mounting bracket securely fastened to a framing structure beneath a personnel door;
a platform deck having a non-slip surface mounted to a sliding mechanism securely fastened to the mounting bracket, wherein the platform deck is operable to be slidably configured in a stowed position beneath the framing structure and a deployed position extending substantially horizontally beyond the personnel door;
a latching mechanism operable to lock the platform deck in one of the stowed position and the deployed position; and
a ladder accessory having at least one step having a non-slip surface operable to be slidably configured in a stowed position beneath the platform deck and a deployed position extending beyond the platform deck.

17. The personnel platform of claim 16, wherein the ladder accessory comprises:
a ladder having a plurality of steps;
a pair of side rails coupled to the platform deck and defining a pair of elongated slots, the slots defining a detent at one end adapted to engage the ladder in a fully-stowed position, and a termination end adapted to engage the ladder in a fully-extended and lowered position.

18. The personnel platform of claim 16, further comprising a safety railing detachably mounted on the platform deck.
